(19) United States
(12) Patent Application Publication
(10) Pub. No.: US 2009/0044698 A1
(43) Pub. Date: Feb. 19, 2009

(54) VACUUM PRESSURE SWING ABSORPTION SYSTEM AND METHOD

(75) Inventor: G.B. Kirby Meacham, Shaker Heights, OH (US)

Correspondence Address: EDWARDS ANGELL PALMER & DODGE LLP, P.O. BOX 55874, BOSTON, MA, 02205, US

(73) Assignee: MEACHAM COMPANY, Shaker Heights, OH (US)

(21) Appl. No.: 12/092,574

(22) PCT Filed: Nov. 6, 2006
(86) PCT No.: PCT/US06/43792

§ 371 Date: Oct. 21, 2008

Related U.S. Application Data
(60) Provisional application No. 60/733,827, filed on Nov. 4, 2005.

(51) Int. Cl. B01D 53/047

(52) U.S. Cl. 95/21; 96/114

(57) ABSTRACT

A vacuum pressure swing absorption (VPSA) system and a four-cycle method are provided for separating and concentrating one portion of a gas mixture. A reciprocating piston (6) and associated valves and conduits can be combined with a bed of selective porous absorbent material (2) to produce concentrated oxygen from ambient air. The piston and valves are arranged to induct a feed gas mixture, produce product gas at a specified output pressure, regenerate the porous absorbent material, and expel depleted gas. Such an arrangement can result in higher energy efficiency as compared to conventional processes since free expansion losses are substantially avoided. The product gas flow can be adjusted to meet demand while maintaining high energy efficiency.

### CROSS-REFERENCE TO RELATED APPLICATION(S)

The present application claims the benefit of U.S. provisional application No. 60/733,827 filed Nov. 4, 2005, which is incorporated herein by reference in its entirety.

### FIELD OF INVENTION

The present invention relates to vacuum pressure swing absorption (VPSA) systems and methods that separate and concentrate at least one portion of a gas mixture, and in particular to a VPSA system and a four-stroke method that separate oxygen from ambient air and produce oxygen-enriched product gas for respiration by medical patients.

### BACKGROUND OF THE INVENTION

VPSA cycles are widely used in electrically powered oxygen concentrators that produce a few liters per minute of approximately 90% oxygen gas from 21% oxygen ambient air. The enriched gas is collected in a receiver vessel at 0.5 to 1.0 bar above ambient, and a pressure and flow regulator controls the flow to the patient. Such devices, also known as concentrators, are particularly useful for patients receiving oxygen as respiratory therapy in a home setting, since they eliminate the difficulty of handling high-pressure oxygen bottles and are more economical.

In operation, these conventional concentrators utilize properties of molecular sieves, particularly zeolites. Zeolites are natural or synthetic porous crystalline materials typically containing silica, alumina, and alkaline metal oxides. Cavities in the material are interconnected by small passages in the range of 3 to 15 angstroms diameter. In any given zeolite composition the passage diameter may be controlled within a narrow range. When granules of the molecular sieve are exposed to a pressurized gas mixture, molecules smaller than the passages flow through the pores into the cavities, while larger molecules are excluded. This physical effect is augmented by a chemical adsorption process that is selective for the absorbed molecular species. The pressurized gas mixture surrounding the molecular sieve granules is therefore enriched in the excluded molecular species as the absorbed species enter the cavities. When the gas pressure is dropped, the molecular sieve releases the absorbed molecular species. The absorption process is exothermic and releases sensible heat, and the release process is endothermic and absorbs sensible heat. The ratio of the maximum absolute absorption pressure to the minimum absolute release pressure, not the absolute pressure is the more important process parameter. As a result, vacuum is often used in the release process to reduce the peak pressure requirement while maintaining a favorable pressure ratio. Performance in terms of product gas for a given amount of absorbent material generally improves with pressure ratio, however energy consumption may increase.

Prior art VPSA systems, particularly small systems used for respiratory therapy by individual patients, have deficiencies. The small, high speed motor driven pumps typically used are noisy, and may be an annoyance in clinical and residential settings where the systems are typically used. Further, low efficiency is a problem, and electric power consumption is high enough to discourage the use of such VPSA systems. Further, in certain cases, health care insurance will reimburse the cost of bottled oxygen, but not the cost of electric power to operate an oxygen concentrator. Free expansion losses are one source of inefficiency. Three fixed pressures are typically used: the pressure pump outlet, ambient, and the vacuum pump inlet. When, for example, a valve is opened to connect the pressure pump outlet to a media bed at ambient pressure there is an initial inrush flow. This is an irreversible free expansion that causes an energy loss, and may also contribute to noise. More generally, whenever a valve with a pressure differential is opened there is an energy loss. Given the fixed pressures available, these losses occur each time media bed pressure is raised or lowered. Operation at reduced product gas flow is another source of inefficiency. Reduced flow rates increase the receiver pressure and may increase rather than reduce the power consumption at reduced flow.

It would be desirable to provide a vacuum pressure swing absorption (VPSA) system and method incorporating a four-stroke VPSA module having a simple design and which is capable of being operated in a substantially energy-efficient manner.

### SUMMARY OF THE INVENTION

The present invention is directed to a vacuum pressure swing absorption (VPSA) system and method utilizing a four-stroke VPSA device or module that combines a single reciprocating piston with a single media bed. The VPSA module preferably is self-contained such that it can carry out all operations necessary to induct feed gas, produce product gas at a specified output pressure, and expel depleted gas. The VPSA module is simple and energy-efficient as compared to conventional systems. In accordance with the present invention, a plurality of VPSA modules can be combined to obtain higher capacity or more uniform product gas flow. Further, the invention is directed to systems and methods of adjusting the product gas flow rate.

The four-stroke VPSA device or module preferably incorporates a plurality of components as described herein. The device includes a pressure vessel having inlet and outlet ends, where the pressure vessel contains a bed of selective porous absorbent material, also referred to herein as a media bed. The media bed preferably includes one or more types of granular media such as Nitroxy 5 and Nitroxy 51, which are Siliporite molecular sieves supplied by SECA S.A. for use in VPSA oxygen concentrators. Additional sorbent examples are high performance lithium-containing zeolites described in “Limits for Air Separation by Adsorption with LiXZeolite” by Rege and Yang in Industrial Engineering Chemical Research 36, pp. 5358-5365 (1997).

The pressure vessel and media bed are arranged such that a gas flowing through the vessel passes through and contacts the media contained in the media bed. The pressure vessel is operably connected to a piston-and-cylinder arrangement, where the piston and cylinder preferably provide pressure and vacuum pumping functions. A displacement volume of the cylinder is selected such that a single piston stroke can supply sufficient air to utilize the nitrogen absorption capacity of the media bed.

Other components of the VPSA device include a motor and a speed reducer, which drive a crank and a connecting rod that reciprocate the piston in the cylinder, where the crank speed preferably is set such that the flow rate of air into the media bed is reasonably matched to the rate of nitrogen absorption in the media. A conduit connects the outlet end of the media bed to a product gas receiver that stores product gas and delivers it to the product gas outlet. The conduit includes an outlet check valve that permits flow to the product gas receiver while preventing backflow. The conduit may also include a product gas backflush reservoir between the outlet end of the media bed and the outlet check valve. An additional conduit connects the cylinder to the cycle valve. The cycle valve preferably has three positions, namely either closed, open to ambient inlet air, or open to the depleted gas exhaust conduit. The depleted gas exhaust conduit includes an exhaust check valve that permits outflow and prevents ambient air backflow. A control system operates the cycle valve in a timed relationship to the piston motion to carry out a four-stroke VPSA oxygen concentration process. The cycle valve preferably goes through one complete cycle in two crank revolutions.

In accordance with the present invention, a single media bed is provided in the VPSA device. Media beds optimized for short absorption and regeneration times, e.g., approximately 0.5 seconds for each operation, are preferred for therapeutic oxygen separators, since they allow crank rotation of about 60 rpm. This is fast enough to result in reasonable piston displacement volumes, for example, four 0.5 liter pistons will deliver about 3 liters of product gas per minute. It is also slow enough to minimize mechanical and fluid flow noise. This example is illustrative, and does not limit the present invention.

The four-stroke VPSA oxygen concentration process of the present invention includes the following strokes: a first stroke for receiving inlet air, a second stroke for adsorbing pressure, a third stroke for backflushing media, and a fourth stroke for exhausting depleted gas.

In the first stroke, the cycle valve is opened to ambient inlet air and the piston motion draws air into the cylinder. The cycle valve is closed to ambient inlet air near the end of the inlet stroke.

In the second stroke, the cycle valve is closed and the piston motion pumps air from the cylinder into the media bed. As the piston moves, the pressures in the cylinder and media bed rise together. The media bed absorbs nitrogen from the pressurized air, and oxygen-enriched product gas flows through the backflush reservoir and the outlet check valve to the product gas receiver. The peak pressure in the cylinder and media bed are approximately the same as in the product gas receiver. The outlet check valve closes as the product gas flow ceases at the end of the stroke.

In the third stroke, the cycle valve and the outlet check valve remain closed. The piston motion pumps depleted gas from the media bed, reducing the pressure smoothly. At the beginning of the third stroke the pressure in the media bed is above ambient and at the end it is below. The pressure drop removes nitrogen from the media. At the same time product gas from the backflush reservoir counterflows through the media bed to purge additional nitrogen.

In the fourth stroke, the cycle valve is open to the depleted gas exhaust conduit. At the beginning of the fourth stroke, the depleted gas is below ambient pressure. The exhaust check valve prevents transient backflow of ambient-pressure gas into the cylinder when the cycle valve is opened. When the depleted gas reaches ambient pressure the exhaust check valve opens and the piston expels the depleted gas at near ambient pressure. The media bed and conduit are repressurized to ambient pressure with depleted gas during the initial portion of the fourth stroke.

The overall result is a stand-alone four-stroke process in which the second stroke delivers product gas. This process is more reversible than conventional VPSA processes operating between fixed pressures. Free expansion losses are minimized since the valves are opened or closed when the pressure across the valves is very low. The piston raises and lowers the gas pressure gradually so that only the amount of compression power needed at each instant of the cycle is consumed, and expansion power is returned to the crank. Such power recovery may reduce net power consumption and waste heat generation. The relatively short cycle provides a further thermal advantage. The sensible heat added to the media during the exothermic absorption process does not have time to dissipate before the endothermic regeneration process. The effect is to reduce the pressure swing for a given product gas output and thereby reduce the power consumption. Additional modules may be added to increase capacity and provide more uniform output flow, but are not necessary for system operation. Further, the process does not require a separate compressor or vacuum pump.

The present invention also can adjust product gas production to meet changing flow demand at relatively constant efficiency. In one embodiment, a control system can be used that measures the receiver pressure and increases or decreases the piston cycling rate to maintain a pressure that results in the desired flow. For example, a variable speed electric motor or a constant speed motor and a variable ratio mechanical drive may be used to rotate the crank. In another embodiment, a control system can be used that measures the receiver pressure and varies the cycle valve closing point near the end of the first stroke to adjust the volume of air inducted. For example, if the valve closing is delayed until after the piston motion has reversed, part of the air will flow back to the atmosphere and less air will be compressed and processed in the second stroke. With fast valve motion there is little pressure drop across the valve when it closes, minimizing free expansion losses. Early valve closing has a similar effect. In either case the expansion volume in the third stroke is larger than the compression volume in the second stroke, thereby increasing the backflush vacuum.

One advantage of the present invention is that it exploits the efficiency of cyclic piston VPSA systems in a simple form that is suitable for consumer applications such as home oxygen concentrators. The maximum absorption pressure can be about 0.5 to 1.0 bar above ambient. This is a good match to the receiver vessel pressure requirement, thereby providing an efficient process without the complexity of a product gas energy recovery piston. Efficiency is further increased since the four-cycle piston process uses vacuum to increase the pressure ratio without the need for a separate vacuum pump.

Another advantage of the present invention is that piston stroke rate or inlet valve timing provides a mechanism for adjusting the flow rate without loss of efficiency.

A further advantage of the present invention is that it permits economical system construction and low noise. Low rotational speed and peak pressure, e.g., 60 rpm and about 0.5 to 1.0 bar above ambient are feasible and are not mechanically demanding, resulting in acceptable manufacturing costs and low operating noise.

The present invention is described in terms of air separation to produce oxygen, but it is not limited to this application. It will be apparent to those skilled in the art that the present invention may be adapted to other gas separation applications such as hydrogen concentration, carbon dioxide removal, and air drying by appropriate selection of the media bed material and the cycle speed and pressure levels. The invention can further incorporate a crank-operated piston and cylinder to carry out the four-cycle volume displacement process. It will be apparent to those skilled in the art that the piston may be reciprocated by other mechanisms including hydraulic cylinders, servomotors actuating racks or screws, linear actuators or manually operated linkages. Additionally, it is apparent that the four strokes may be of different lengths or different speeds. Finally, it will be obvious to those skilled in the art that a bellows, diaphragm, or other known fluid displacement devices may replace the piston.

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is a schematic view of a single VSPA module according to the present invention;

FIG. 2 is a schematic view of the inlet air stroke of the single VSPA module of FIG. 1;

FIG. 3 is a schematic view of the pressure adsorption stroke of the single VSPA module of FIG. 1;

FIG. 4 is a schematic view of the media backflush stroke of the single VSPA module of FIG. 1;

FIG. 5 is a schematic view of the depleted gas exhaust stroke of the single VSPA module of FIG. 1; and

FIG. 6 is a graph depicting the media bed pressure as a function of crank angle for the VSPA process of the present invention.

### DESCRIPTION OF THE PREFERRED EMBODIMENT(S)

The present invention is directed to a four-stroke VPSA device and process that combines a single reciprocating piston with a single media bed, producing a relatively simple design that can provide improved energy efficiency as compared to conventional VPSA devices.

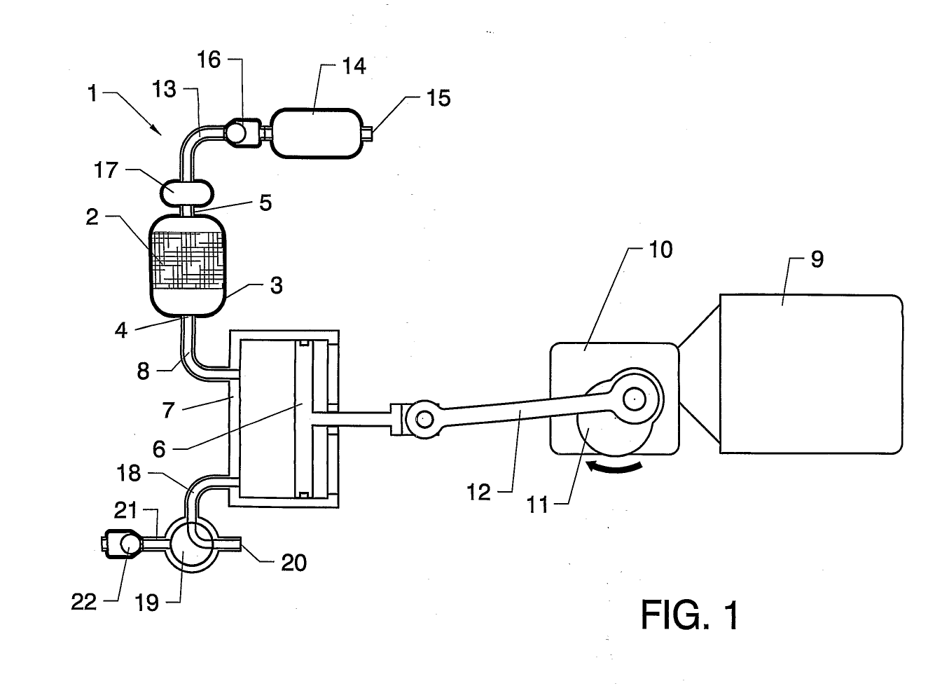

A VPSA device or module 1 is depicted schematically in FIG. 1. A bed containing selectively absorbent porous material, also known as a “porous material bed” or “media bed” 2 filled with media is contained in a pressure vessel 3 having an inlet end 4 and an outlet end 5. The media bed 4 is arranged such that gas flowing through the pressure vessel 3 passes through and contacts the media provided in the media bed 2. A cyclic gas displacement device such as a piston 6 and cylinder 7 are configured to provide pressure and vacuum pumping functions. Preferably only one piston and cylinder arrangement are needed to provide pressure and vacuum pumping functions in the system, where the one piston and cylinder arrangement is operably connected to a single pressure vessel containing the media bed. To maintain a simple design, it is preferred to provide the media bed and the piston and cylinder arrangement in a one-to-one ratio. The piston displacement volume is selected such that a single piston stroke supplies sufficient air to utilize the nitrogen absorption capacity of the media bed 2. A first conduit 8 connects the cylinder 7 to the inlet end 4 of the pressure vessel 3. A motor 9 and a speed reducer 10 drive a crank 11 and a connecting rod 12 that reciprocate the piston 6 in the cylinder 7. A rotational speed of the crank 11 is set such that the flow rate of air into the media bed 2 is substantially matched to the rate of nitrogen absorption in the media bed 2.

A second conduit 13 connects the outlet end 5 of the pressure vessel 3 to a product gas receiver 14 that stores product gas and delivers it to a product gas outlet 15. The second conduit 13 includes an outlet check valve 16 that permits flow to a product gas receiver 14 while preventing backflow. The second conduit 13 also includes a product gas backflush reservoir 17 arranged between the outlet end 5 of the pressure vessel 3 and the outlet check valve 16. The backflush reservoir 17 may be a pressure vessel as shown. Alternatively, the backflush reservoir 17 may be omitted entirely, and its function can be performed in part or in total by free volume in the second conduit 13 and the pressure vessel 3 located between the media bed 2 and the outlet check valve 16. A third conduit 18 connects the cylinder 7 to a cycle valve 19.

The cycle valve 19 preferably has three positions: closed, open to an ambient air inlet 20, or open to a depleted gas exhaust conduit 21 at ambient pressure. The depleted gas exhaust conduit 21 includes an exhaust check valve 22 that permits outflow and prevents backflow. A control system (not shown) operates cycle valve 19 in a timed relationship to the motion of piston 6 to carry out the four-stroke VPSA oxygen concentration process. The cycle valve 19 goes through one complete cycle in two crank revolutions. The cycle valve 19 may be of any suitable type or configuration known in the art.

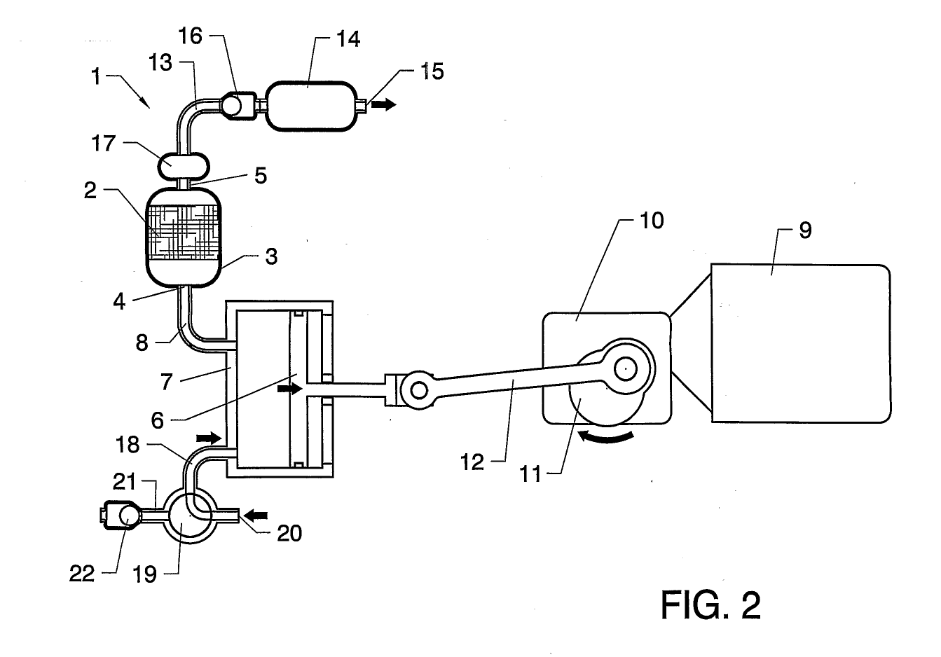

The four strokes of the VPSA oxygen concentration process of the present invention are illustrated in FIG. 2 through FIG. 5.

FIG. 2 illustrates a first stroke, also known as “Stroke 1” or an inlet air stroke. In Stroke 1, the cycle valve 19 is opened to the ambient air inlet 20, and the crank 11 and connecting rod 12 move the piston 6 to the right, drawing air into the cylinder through the conduit 18. The outlet check valve 16 is closed during Stroke 1, and the media bed 2, the pressure vessel 3, the conduit 8, and the cylinder 7 are slightly below ambient pressure. The cycle valve 19 is closed to the ambient air inlet 20 near the end of Stroke 1. The cycle valve 19 closing point may be varied relative to the piston stroke to adjust the volume of air inducted. For example, if the cycle valve 19 closing is delayed until after the piston motion has reversed and started moving to the left in Stroke 2, part of the air flows back to the atmosphere and less air is compressed and processed in Stroke 2. There is negligible pressure drop across the cycle valve 19 prior to closing, and if the valve action is fast free expansion losses are minimal. Early closing of the cycle valve 19 has a similar effect. The cylinder 7 does not completely fill with air, and less air will be compressed and processed in Stroke 2. In this case piston motion forms a transient partial vacuum at the end of Stroke 1 and the beginning of Stroke 2. This vacuum has little net effect on power consumption since the power consumed at the end of Stroke 1 is returned to the crank at the beginning of Stroke 2.

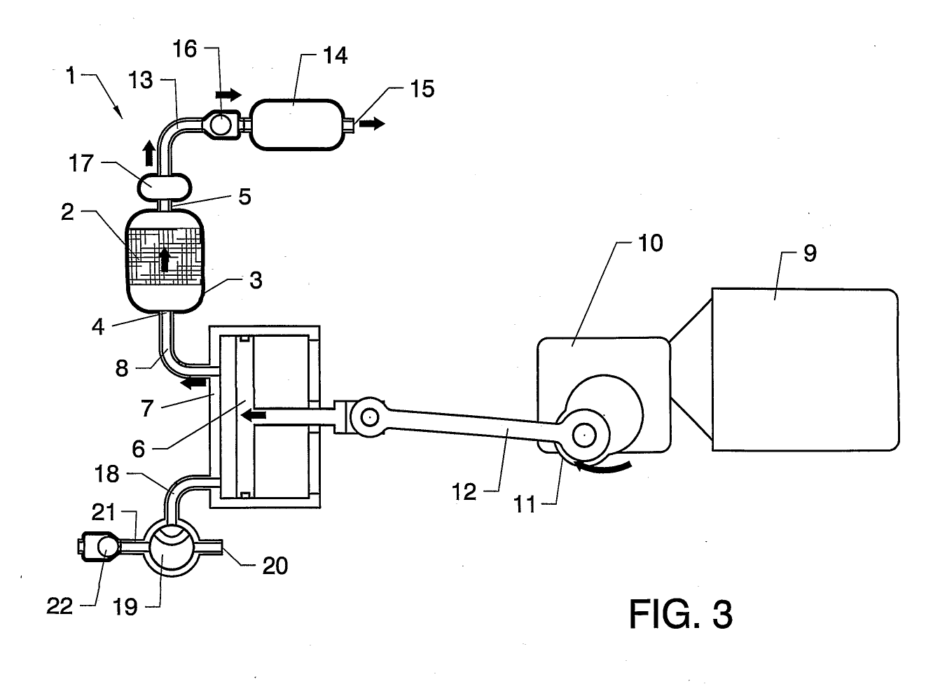

FIG. 3 illustrates a second stroke, also known as “Stroke 2” or a pressure adsorption stroke. In Stroke 2, the cycle valve 19 is closed and the crank 11 and connecting rod 12 move the piston 6 to the left, pumping air through the conduit 8, the media bed 2, and the pressure vessel 3. The media bed 2 absorbs nitrogen from the air passing through, forming product gas that fills pressure vessel 3 between the media bed 2 and the outlet port 5, the conduit 13, and the backflush reservoir 17. As the piston moves, the pressures in the cylinder 7, the media bed 2, the pressure vessel 3, the conduit 13, and the backflush reservoir 17 rise together. When the product gas pressure rises above the pressure in the product gas receiver 14, the outlet check valve 16 opens and product gas flows into the product gas reservoir 17. The outlet check valve 16 closes as the product gas flow ceases at the end of Stroke 2.

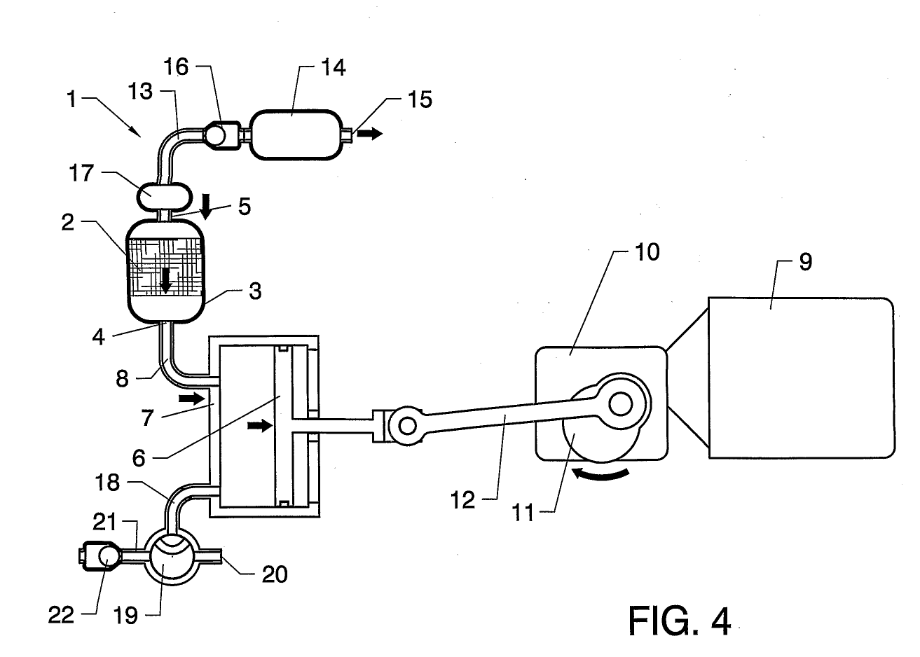

FIG. 4 illustrates a third stroke, also known as “Stroke 3” or a media backflush stroke. In Stroke 3, the cycle valve 19 and the outlet check valve 16 remain closed, and the crank 11 and connecting rod 12 move the piston 6 to the right, reducing the pressure in the cylinder 7, the media bed 2, the pressure vessel 3, the conduit 13, and the backflush reservoir 17. At the beginning of Stroke 3, the pressure in the media bed 2 is above ambient and at the end of Stroke 3, the pressure is below ambient. This pressure drop removes absorbed nitrogen from the media forming nitrogen-rich depleted gas. At the same time product gas from the backflush reservoir 17 counterflows through the media bed 2 to purge additional nitrogen. At the beginning of Stroke 3, the pressure in the media bed is above atmospheric and at the end it is below.

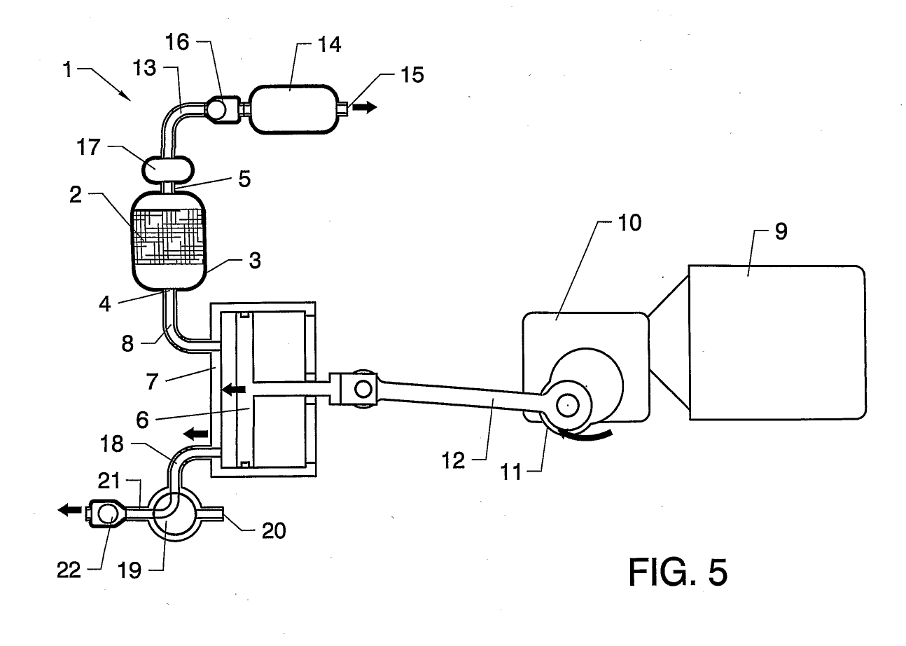

FIG. 5 illustrates a fourth stroke, also known as “Stroke 4” or a depleted gas exhaust stroke. In Stroke 4, the cycle valve 19 is open to the depleted gas exhaust conduit 21, and the exhaust check valve 22 and the outlet check valve 16 are closed. The crank 11 and connecting rod 12 move the piston 6 to the left. At the beginning of Stroke 4, the depleted gas is below ambient pressure, and the exhaust check valve 22 prevents transient backflow of ambient-pressure gas into the cylinder 7 when the cycle valve 19 is opened. Instead, the sub-atmospheric pressure assists the piston motion and returns power to the crank 11 until the depleted gas reaches atmospheric pressure. When the piston motion reduces the depleted gas volume to the point it reaches ambient pressure, the exhaust check valve 22 opens and the piston 6 expels the depleted gas through depleted gas exhaust conduit 21 at near ambient pressure. Stroke 4 adds power to the crank. The media bed and the conduit are repressurized to ambient pressure with depleted gas during the initial portion of Stroke 4.

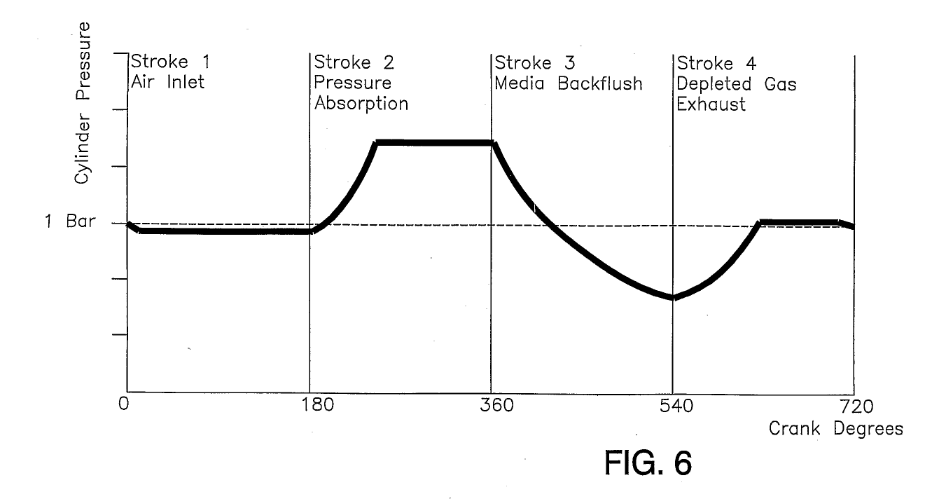

FIG. 6 shows the pressure as a function of crank angle for the four strokes. Stroke 1, is a low power portion of the cycle since the air inlet flow is near atmospheric pressure throughout the stroke. Stroke 2 draws a high level of power from the crank and motor. Stroke 3 returns power to the crank until the depleted gas pressure reaches atmospheric pressure, and draws power after it drops below atmospheric. Stroke 4 adds power to the crank until the pressure rises to ambient, and then draws a low amount of power as the gas is expelled to ambient pressure.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications, and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A vacuum pressure swing absorption system for separating and concentrating at least one component of a gas mixture, comprising:
a pressure vessel having an inlet port and an outlet port, the pressure vessel containing a porous material bed arranged such that the gas mixture passing from the inlet port to the outlet port passes through a porous material bed, the porous material bed selectively absorbing at least one component of the gas mixture at a first higher pressure and desorbing the at least one component at a second lower pressure;
a cyclic gas displacement device having a variable volume chamber fluidly connected to the inlet port of the pressure vessel;
a cyclic control valve fluidly connected to the variable volume chamber of the cyclic gas displacement device for controlling at least an air intake and an exhaust of depleted gas of the gas mixture; and
a product gas output conduit fluidly connected to the outlet port of the pressure vessel, the product gas output conduit configured to receive a product gas separated from the gas mixture.

2. The vacuum pressure swing absorption system of claim 1, wherein the cyclic gas displacement device is the only device that provides pressure and vacuum pumping in the system.

3. The vacuum pressure swing absorption system of claim 1, wherein the porous material bed is operably connected to a single cyclic gas displacement device.

4. The vacuum pressure swing absorption system of claim 1, wherein the cyclic gas displacement device is a reciprocating displacer.

5. The vacuum pressure swing absorption system of claim 4, wherein the reciprocating displacer is a piston and cylinder.

6. The vacuum pressure swing absorption system of claim 1, wherein the cyclic control valve is adjustable relative to the motion of the cyclic gas displacement device.

7. The vacuum pressure swing absorption system of claim 1, further including a depleted gas exhaust conduit and an exhaust check valve operably connected to the cyclic control valve.

8. The vacuum pressure swing absorption system of claim 1, wherein the product gas output conduit is operably connected to a check valve permitting flow from the product gas output conduit into a product gas receiver and preventing flow from the product gas receiver into the product gas output conduit.

9. The vacuum pressure swing absorption system of claim 1, further including a backflush reservoir fluidly connected to the product gas output conduit for increasing a purge volume of the product gas.

10. The vacuum pressure swing absorption system of claim 1, further including a motor driven crank and a connecting rod assembly for driving the cyclic gas displacement device.

11. The motor driven crank and connecting rod assembly of claim 10, wherein the crank rotational speed is varied to adjust the product gas output flow.

12. A vacuum pressure swing absorption method for separating and concentrating at least one component of a gas mixture, comprising the steps of:
opening a cyclic control valve and operating a cyclic gas displacement device to receive a selected quantity of the gas mixture;
closing the cyclic control valve and operating the cyclic gas displacement device to pump the gas mixture into a media bed, wherein a pressure in the media bed is raised such that the media bed absorbs a portion of the gas mixture to form a product gas depleted of an absorbed component, the product gas capable of flowing out of the media bed to a product gas receiver, and a remaining portion of the gas mixture being retained in the media bed;
operating the cyclic gas displacement device to pump the remaining portion of the gas mixture from the media bed to reduce the media bed pressure, wherein the media bed releases the absorbed component to form a depleted gas mixture and purges the media bed with backflow of a portion of the product gas from the product gas receiver;
opening the cyclic control valve and operating the cyclic gas displacement device to discharge the depleted gas mixture; and
repressurizing the media bed to ambient pressure using a portion of the depleted gas.

13. The method of claim 12, wherein the depleted gas mixture is discharged at the same time the media bed is repressurized to ambient pressure.

14. The method of claim 12, wherein the cyclic gas displacement device is operable in four strokes.

15. The method of claim 12, wherein the cyclic gas displacement device is the only device that provides pressure and vacuum pumping.

16. The method of claim 12, wherein the cyclic gas displacement device is driven by a motor driven crank and a connecting rod assembly.
